(19) United States
(12) Patent Application Publication
(10) Pub. No.: US 2003/0065598 A1
(43) Pub. Date: Apr. 3, 2003

(54) Methods and systems for managing a portfolio of securities

(76) Inventor: John Bunda, Austin, TX (US)

Correspondence Address: ERIC B. MEYERTONS, CONLEY, ROSE & TAYON, P.C., P.O. BOX 398, AUSTIN, TX, 78767-0398, US

(21) Appl. No.: 09/970,078

(22) Filed: Oct. 3, 2001

(51) Int. Cl. G06F 17/60

(52) U.S. Cl. 705/36

(57) ABSTRACT

Embodiments disclosed herein provide a computer implemented method and system that may allow a securities trader to receive a notification if a trigger condition is met. Additionally, the method and system may automatically transfer an order for execution if the trigger condition is met. The trigger condition may be user configurable. Additional user configuration information may include, but is not limited to: a discretionary limit, and a transaction type (e.g., buy or sell). The method and system may continuously, or at discrete intervals, provide information regarding the execution status of orders. The trigger condition may include a “trailing trigger price.” The trailing trigger price may vary with a corresponding market price in a favorable direction. The trailing trigger price may remain static if the corresponding market price moves in an unfavorable direction.

### BACKGROUND OF THE INVENTION

1. Field of the Invention

The present invention generally relates to computer software. Certain embodiments relate to a computer-implemented method to provide trader alert notifications, and/or automated trades.

2. Description of the Related Art

The securities trading industry has burgeoned since the advent of the Internet. Many companies offer securities trading services through a variety of automated systems/methods such as a telephone system or a computer system. The placement of orders to buy or sell securities may be done using an order entry screen on a computer system. Before placing an order, a trader of securities may review technical analysis data and/or quotes which may aid in making trading decisions.

A trader may buy or sell a security using a variety of different types of orders. Each type of order may specify how a broker is to execute the order. Different types of orders may be used by a trader to accomplish different goals. Examples of types of orders a trader may use include, but are not limited to: a market order, a limit order, a limit order with discretion (or discretionary limit order), and a stop order.

In addition to the types of orders listed above, many other variations or combinations may exist. Orders may be very complex. Particular brokers may require that complex orders be placed in person by a trader. Placing an order in person may be time consuming. Tracking the execution of complex orders may be difficult.

An additional concern with certain types of orders may be that their execution is unpredictable. For example, a limit or stop type order may not execute for an extended period of time. Typically, a broker may leave a limit or stop type order in place for up to 60 or 90 days. By the time a limit order executes, market conditions may have changed such that the transaction is no longer desirable. It may therefore be desirable to provide a securities trader with a method of receiving a notification regarding market condition, so that the trader may determine if a planned transaction is still desirable when the monitored market condition meets a trader configured trigger condition.

### SUMMARY OF THE INVENTION

Embodiments disclosed herein provide various methods and systems to provide a securities trader alert notifications, and/or automated trades.

In an embodiment, a computer implemented method of providing a notification to a trader may include receiving configuration information from the trader. The configuration information may include a trigger condition and a request to send a notification to the trader. The method may also include receiving market price information regarding at least the one security, and determining if a market price from the received market price information meets the trigger condition. The market price may include at least one bid price, or at least one ask price. If the trigger condition is met, a notification may be sent to the trader. In some embodiments, the method may also include transferring an order to an entity for execution if the market price from the received market price information meets the trigger condition. In such embodiments, the configuration information may include an order for at least one security. After the order is transferred, information regarding the order may be displayed to the trader.

Configuration information for such a method may also include, but is not limited to: a position opening order, a position closing order, a market center preference, a discretionary limit value, a discretionary limit price, a stop loss value, and/or a stop loss price. A trigger condition may include a trigger relationship, a trigger price, and/or a trigger value. For example, the trigger relationship may be a less than, less than or equal to, equal to, greater than or equal to, or greater than relationship. The configuration information may be provided by the trader along with a position opening order, after a position has been opened, or before a position has been opened.

The trader may be notified by an electronic mail sent to the trader, a page sent to the trader, or a text box displayed to the trader on a user interface. The method may also include generating at least one chart using the market price information. The at least one chart may include a display of a configured trigger price or trigger value.

In certain embodiments, a computerized trading system may be configured to alter a trigger condition in a predetermined fashion based on market conditions. In this manner, a “trailing trigger condition” may be configured. An advantage of such embodiments may be that they may allow the trader to profit from favorable market movement and retain the profit if market conditions become unfavorable. In such embodiments, a trigger condition may include, but is not limited to: a trailing trigger relationship, a trailing stop loss initial value, a trailing stop loss initial price, a pullback value, a trailing trigger value, and/or a trailing trigger price. A trailing trigger relationship may include a trailing buy or a trailing sell relationship

Additional embodiments may include a computer memory medium or computer system configured to implement a method as described above. Additional embodiments may include implementing a method as described above on two or more computers connected by a network. For example, the network may include the Internet.

### BRIEF DESCRIPTION OF THE DRAWINGS

FIG. 1 is a network diagram of a wide area network suitable for implementing various embodiments;

FIG. 2 is an illustration of a typical computer system suitable for implementing various embodiments;

FIG. 3 is a flow chart of an embodiment of a computer-implemented method to provide a trader with a notification regarding market data;

FIG. 4 depicts an exemplary embodiment of a user interface screen useful for configuring a notification and/or order;

FIG. 5 depicts an exemplary embodiment of a user interface screen useful for configuring default values for notifications and/or orders;

FIG. 6 depicts an exemplary embodiment of a user interface screen useful for configuring a notification and/or order;

FIG. 7 depicts an exemplary embodiment of a user interface screen useful for configuring a market center preference list;

FIG. 8 is a flow chart of an embodiment of a computer implemented method to provide a trader with a notification regarding market data; and

FIG. 9 depicts an exemplary embodiment of a user interface screen useful for configuring a notification and/or order.

While the invention is susceptible to various modifications and alternative forms, specific embodiments thereof are shown by way of example in the drawings and will be described in detail herein. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF SEVERAL EMBODIMENTS

Embodiments described herein may interact with other securities trading systems and methods. For example, embodiments described herein may interact with systems and methods described in co-pending U.S. patent application Ser. No. 09/460,045 which is incorporated by reference as if full set forth herein.

As used herein, a “security” refers to an investment instrument, issued by a corporation, government, or other organization which offers evidence of debt or equity (e.g., stocks, options contracts, futures, bonds, mutual funds, and other investments). As used herein, “technical analysis” refers to a method for evaluating securities by relying on the assumption that market data (e.g., charts of price, volume, and open interest) may help predict future market trends. As used herein, a “market trend” may generally refer to a change in one or more market prices over time. As used herein, an “order” refers to a solicitation to buy a specified quantity of a particular security or an offer to sell a specified quantity of a particular security.

As used herein, a “market order” may refer to a solicitation to buy or sell a security at the best trade price available when the order executes. As used herein, “trade price” (or “market price”) may refer to an ask price if a security is being purchased, or a bid price if a security is being sold. A “bid price” may refer to the price a trader is willing to pay to purchase a security. An “ask price” may refer to the price a trader is willing to accept to sell a security. As used herein, a “limit order” refers to an order to buy a specified quantity of a security at or below a specified price or to sell the security at or above a specified price. As used herein, a “limit price” may refer to the price specified in a limit order. A limit order will not execute if the order is a sell order and the bid price is less than the limit price. If the order is a buy order, the limit order will not execute if the ask price is greater than the limit price. As used herein, a “limit order with discretion” (or “discretionary limit order”) refers to an order to buy a specified quantity of a security within a range of a specified price or to sell the security within a range of a specified price. The range around the specified price of an order may be referred to as a “discretionary limit.” A discretionary limit may typically be about 0.125 to 0.25 of a point. As used herein, a “stop order” may refer to an order to place a market order if a security's trade price reaches or passes a predetermined stop price. A “stop price” may refer to the price limit given in a stop order. A stop order differs from a limit order in that, if the stop price of a stop order is reached, a market order is sent. Therefore, a stop order may execute even though market movement may have caused the bid price to drop below the stop price; or the ask price to go above the stop price.

A “trigger price” may refer to a market price at which the computerized trading system takes some predefined action. As used herein, a “trigger relationship” may refer to a predetermined characteristic of a market price in relation to a trigger price. The predetermined characteristic may be that the market price is greater than, greater than or equal to, equal to, less than or equal to, or less than the trigger price. A trigger price in combination with a trigger relationship may be considered a “trigger condition.” A “trailing trigger price” may refer to a trigger price which may be changed in a single direction only as a market price of a security changes. For example, a trailing trigger price may move upward as an associated market price moves upward, but may not move downward as the associated market price moves downward. Alternately, a trailing trigger price may move downward as an associated market price moves downward, but may not move upward as the associated market price moves upward.

As used herein, “real-time” may generally refer to a response to stimuli within some relatively small upper limit of response time (e.g., seconds or minutes). As used herein, “automatically” may generally refer to an action taken without requiring manual steps on the part of the user.

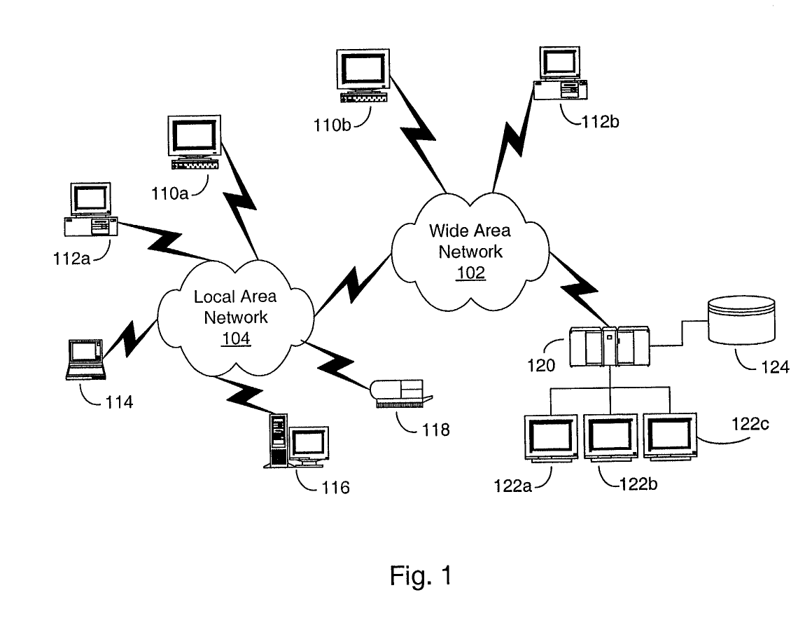

FIG. 1 illustrates a wide area network (WAN) according to one embodiment. WAN 102 is a network that spans a relatively large geographical area. The Internet is an example of WAN 102. WAN 102 typically includes a plurality of computer systems which are interconnected through one or more networks. Although one particular configuration is shown in FIG. 1, WAN 102 may include a variety of heterogeneous computer systems and networks which are interconnected in a variety of ways and which may run a variety of software applications.

One or more local area networks (LANs) 104 may be coupled to WAN 102. A LAN 104 is a network that spans a relatively small area. Typically, a LAN 104 is confined to a single building or a group of buildings. Each node (i.e., individual computer system or device) on a LAN 104 preferably has its own CPU with which it executes programs, and each node is able to access data and devices anywhere on the LAN 104. The LAN 104 thus allows many users to share devices (e.g., printers) as well as data stored on file servers. The LAN 104 may be characterized by any of a variety of types of topology (i.e., the geometric arrangement of devices on the network), of protocols (i.e., the rules and encoding specifications for sending data, and whether the network uses a peer-to-peer or client/server architecture), and of media (e.g., twisted-pair wire, coaxial cables, fiber optic cables, radio waves).

Each LAN 104 includes a plurality of interconnected computer systems and optionally one or more other devices: for example, one or more workstations 110a, one or more personal computers 112a, one or more laptop or notebook computer systems 114, one or more server computer systems 116, and one or more network printers 118. As illustrated in FIG. 1, an example LAN 104 may include one of each of computer systems 110a, 112a, 114, and 116, and one printer 118. The LAN 104 may be coupled to other computer systems and/or other devices and/or other LANs 104 through WAN 102.

One or more mainframe computer systems 120 may be coupled to WAN 102. As shown, the mainframe 120 may be coupled to a storage device or file server 124 and mainframe terminals 122a, 122b, and 122c. The mainframe terminals 122a, 122b, and 122c may access data stored in the storage device or file server 124 coupled to or included in the mainframe computer system 120.

WAN 102 may also include computer systems which are connected to WAN 102 individually and not through a LAN 104: as illustrated, for purposes of example, a workstation 110b and a personal computer 112b. For example, WAN 102 may include computer systems which are geographically remote and connected to each other through the Internet.

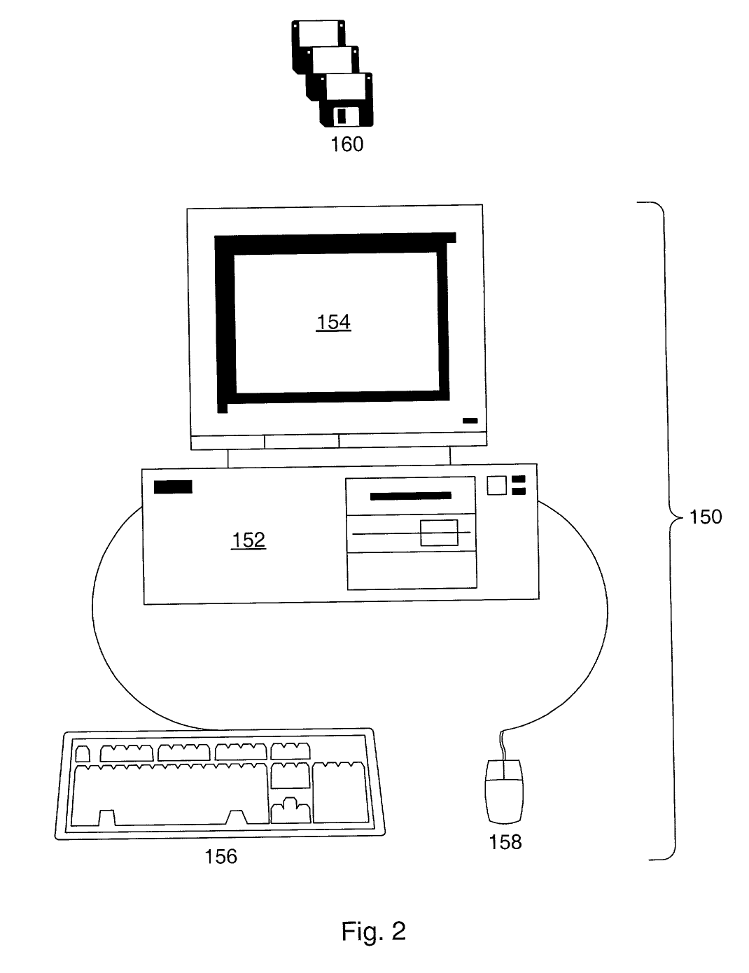

FIG. 2 illustrates a typical computer system 150 which may be suitable for implementing various embodiments disclosed herein. Each computer system 150 typically includes components such as a CPU 152 with an associated memory medium such as floppy disks 160. The memory medium may store program instructions for computer programs, wherein the program instructions are executable by the CPU 152. The computer system 150 may further include a display device such as a monitor 154, an alphanumeric input device such as a keyboard 156, and a directional input device such as a mouse 158. The computer system 150 may be operable to execute the computer programs to implement embodiments described herein.

The computer system 150 preferably includes a memory medium on which computer programs according to various embodiments may be stored. The term “memory medium” is intended to include an installation medium, e.g., a CD-ROM, DVD, or floppy disks 160, a computer system memory such as DRAM, SRAM, EDO RAM, Rambus RAM, etc., or a non-volatile memory such as a magnetic media, e.g., a hard drive, or optical storage. The memory medium may include other types of memory as well, or combinations thereof. In addition, the memory medium may be located in a first computer in which the programs are executed, or may be located in a second different computer which connects to the first computer over a network. In the latter instance, the second computer may provide the program instructions to the first computer for execution. Also, the computer system 150 may take various forms, including a personal computer system, mainframe computer system, workstation, network appliance, Internet appliance, personal digital assistant (PDA), television system or other device. In general, the term “computer system” may be broadly defined to encompass any device having a processor which executes instructions from a memory medium. Additionally, a “computer system” may generally describe hardware and software components that in combination may allow execution of computer programs. Computer programs may be implemented in software, hardware, or a combination of software and hardware.

The memory medium preferably stores a software program or programs for implementing embodiments described herein. The software program(s) may be implemented in any of various ways, including procedure-based techniques, component-based techniques, and/or object-oriented techniques, among others. For example, the software program(s) may be implemented using ActiveX controls, C++ objects, JavaBeans, Microsoft Foundation Classes (MFC), browser-based applications (e.g., Java applets), traditional programs, or other technologies or methodologies, as desired. A CPU, such as the host CPU 152, executing instructions from the memory medium includes a means for creating and executing the software program or programs according to the methods described below.

As used herein, the term “ticker symbol” may refer to a “stock symbol” or another equivalent symbol used to identify a non-stock security. A “stock symbol” refers to a series of letters used to identify a stock or a mutual fund. Stock symbols with up to three letters are typically used to identify stocks which are listed and traded on a stock exchange (i.e., the NYSE: New York Stock Exchange). Stock Symbols with four letters are typically used to identify NASDAQ stocks. NASDAQ (National Association of Securities Dealers Automated Quotation System) is a computerized system established by the National Association of Securities Dealers (NASD) to facilitate trading by providing broker/dealers with current bid and ask price quotes on over-the-counter stocks and some exchange listed stocks. Stock Symbols with five letters are typically used to identify NASDAQ stocks other than single issues of common stock. Stock Symbols with five letters ending in X are typically used to identify mutual funds.

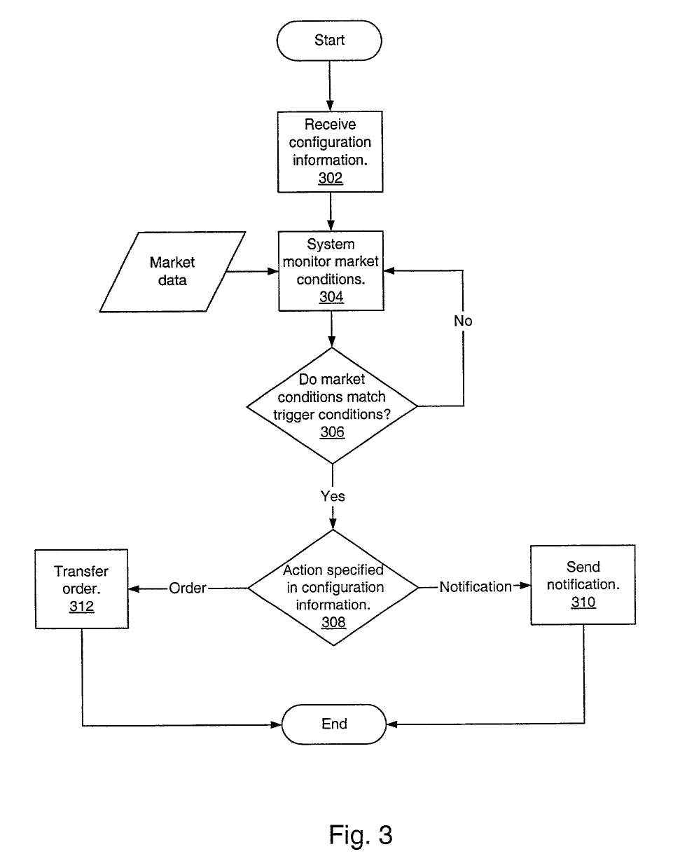

FIG. 3 depicts an embodiment of a computer-implemented method to provide a trader with a notification regarding market data. Additionally, FIG. 3 is a flow chart depicting an embodiment of a computer-implemented method for automatically placing an order based on monitored market data. The method depicted may be carried out independently, or in conjunction with placing an order to establish (or “open”) a position in a security. As used herein, a “position” refers to an amount of a security either: (1) owned or bought (i.e., a long position) or (2) owed or sold (i.e., a short position) by a trader. A trader may initiate the method in order to be notified if a security reaches a predetermined market price. Alternately, a trader may implement the method to hedge the purchase of a security by configuring a position closing order. As used herein, “hedge” may refer to an effort to reduce the risk of adverse price movements in a security. As used herein, “risk” refers to the likelihood of loss or less-than-expected returns.

In an embodiment, a system and method may be provided to allow a trader to submit an order through a computerized trading system. The computerized trading system may receive securities orders from a trader. The received securities orders may be automatically transferred (in real-time or within a specified number of minutes of receiving the securities orders) from a first entity to a second entity for execution of the securities orders. Alternatively, the received securities orders may be automatically transferred from the first entity to one or more intermediate entities and then to the second entity for execution of the securities orders. The first entity may represent a trader. The one or more intermediate entities may represent a broker. The second entity may represent a dealer on a floor of an exchange (e.g. a stock exchange, or an options exchange).

The received securities orders may be stored in a memory coupled to a computer system. The computer system may be a computer system being used by the trader. Alternately, the received securities orders may be entered into a first computer system and stored in a memory coupled to a second computer system. The received securities orders may be stored in memories coupled to both the first and the second computer systems. The second computer system may be coupled to the first computer system over a computer network (e.g., the Internet).

Upon execution of the securities orders, the securities orders may be automatically updated (in real-time or within a specified number of minutes of execution of the securities orders) with execution completion information for the securities orders. The second entity may automatically update the securities orders. The updated securities orders may be transmitted to one or more post-execution entities (e.g., a clearing firm).

In an embodiment, a computerized trading system may be configured to track the execution of limit and stop type orders automatically. The system may be provided with a user interface screen which may provide a trader with real time data regarding the execution of limit and stop type orders. For example, the user interface screen may list executed orders, and pending orders. The computerized trading system may also be configured to generate charts of market activity based on the system's monitoring of market conditions. The system may be configured to display pending limit and stop type orders on charts which depict the change in market price of a security over time. An advantage of such embodiments may be that they may provide a trader with graphical data regarding where a pending limit or stop type order stands in relation to the market trend for the security. In certain embodiments, such a system may be able to calculate and chart other market trends. For example, the system may be able to calculate and chart the S&P 500 index over a period of time. In such embodiments, the system may also be configured to show limit and stop type orders in relation to the market trends.

In an embodiment depicted in FIG. 3, a computer-implemented method to provide a trader with a notification regarding market data may include receiving configuration information from a trader (step 302). The configuration information may include: identifying a security to monitor, identifying a trigger condition, and identifying an action to be taken if the trigger condition is met. In certain embodiments, an action to be taken may include transferring an order if a trigger condition is met. In some such embodiments, the trader may be able to configure various details of the order. For example, details of the order which may be configured by a trader may include, but are not limited to: the type of order (e.g., buy or sell); the discretionary limit, if any; and the preferred order of market centers to contact to fill an order.

A system may be configured to allow a trader to substantially simultaneously submit an order, and to implement the method of FIG. 3. When the method of FIG. 3 is used in conjunction with establishing a position in a security and includes an order to close the position, the method may be referred to as a “stop loss” method. A “stop loss” refers to an order intended to limit or eliminate losses due to a position in a security by closing the position in the security. A trader utilizing the method depicted in FIG. 3 as a stop loss may configure the system such that the trigger price is equal to a price at which the trader desires to close the position held in the security. The system may automatically gather position data, such as, but not limited to: the number of securities in a position, the ticker symbol of the security, and the type of transaction required to close the position. The position data gathered may be used to configure an order or a notification to be provided to the user. The type of transaction required to close the position may be a buy or a sell transaction depending on the type of position. The trader may further configure the system with a trigger relationship. The trigger relationship may depend on the type or transaction required to close the position. For example, if the position is a long position, a sale of the security may be needed to close the position. Generally, a trader may utilize a stop loss to sell a security before the market price of the security becomes too low. Therefore, a trigger relationship may be selected such that the trigger condition is met if the market price becomes equal to, less than or equal to, or less than the trigger price. Conversely, if the position is a short position, a trader may desire to purchase a security before the price of the security becomes too high. In this case, a trigger relationship may be selected such that the trigger condition is met if the market price of the security becomes equal to, greater than or equal to, or greater than the trigger price. The trader may configure the system to automatically transfer an order to close the position when the trigger condition is met. The trader may configure the system to send the trader a notification if the trigger condition is met.

A stock exchange, or stock market may facilitate trading in securities by communicating open quotes and orders. A stock exchange, or stock market may also use market centers to match buyers and sellers of a security. For example, the NASDAQ Stock Market uses the Small Order Exchange System (“SOES”) and Electronic Communication Networks (“ECN”s). Both the SOES and ECNs may be referred to generally as market centers. An ECN may generally refer to an order matching system that may allow traders to advertise a price that may be better than the best (i.e., highest) current bid price or best (i.e., lowest) current ask price for a security. The SOES network is a non-negotiated exchange in which market makers may place offers and bids and may be required to meet fill requirements set forth in a participation agreement with the National Association of Securities Dealers (“NASD”). As used herein, a “market maker” may generally refer to an entity (e.g., a brokerage, a bank) that maintains an orderly market in a security by standing ready, willing, and able to buy or sell the security. On a stock exchange, a “market maker” may also be referred to as a specialist. Examples of ECNs may include Arcapelago (“ARCA”), Bloomberg (“BTRD”), Instinet (“INCA”), Island (“ISLD”), Spear Leeds (“REDI”), and SelectNet (“NASD”).

In an embodiment, a discretionary limit may be configured by a trader to simulate a discretionary limit order. In an embodiment, a computerized securities trading system may be configured to monitor the market price of a security and notify a user if the market price reaches or exceeds (i.e., higher than for a sale, and lower than for a purchase) a specified trigger price. In such an embodiment, the system may attempt to execute a transaction at the best price possible above a specified discretionary limit price. If the transaction cannot be executed after a predetermined number of attempts, or within a predetermined time limit, the system may attempt to execute the transaction at a price worse than the trigger price (i.e., lower than for a sale, and higher than for a purchase). The system may continue to try to execute the transaction until a discretionary limit is reached or until a maximum number of attempts or a maximum amount of time are reached. The trader may provide the discretionary limit price by specifying a trigger price, and a discretionary price. Alternately, the trader may provide the discretionary limit price by specifying a trigger price, and a discretionary range. The trader may also provide the discretionary limit price by specifying a trigger price and a delta amount. The “delta” amount may refer to an amount that may be added to or subtracted from the trigger price to establish a discretionary limit.

As depicted in FIG. 3, a computerized securities trading system may monitor market data (step 304). The system may monitor market data such as: market prices, volumes traded, etc. The system may display some or all of the monitored data to a trader. For example, the system may be configured by the trader to display charts or tables that depict some or all of the monitored data. The charts may include a graphical representation that compares pending user configured notifications or orders to current market conditions and/or market trends.

An embodiment of a computer-implemented method to provide a trader with a notification regarding market data as depicted in FIG. 3, may include comparing monitored market data to user configuration conditions (step 306). If a user configured trigger condition is met, the method may include determining an action to take based on the received configuration information (step 308). If the configuration information includes an order, the method may proceed to step 312 and transfer the order. If the configuration information includes a user notification, the method may proceed to step 310 and send the notification. Sending a notification may include, but is not limited to: sending a notification via an electronic mail system, send a notification via a paging system, or sending a notification via a text box displayed on a user interface. A system may also be configured to periodically, or continuously display the status of pending orders. Since the system may display this information continuously, this step is not depicted in the method flow chart. In some embodiments, the system may be configured to both transfer an order and provide a user notification.

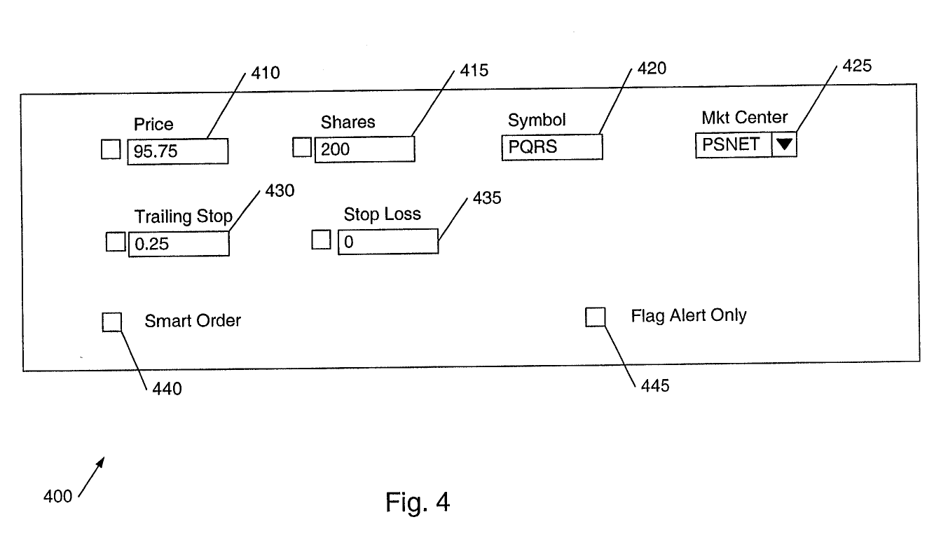

An exemplary embodiment of a user interface screen which may allow a trader to configure a user notification is provided in FIG. 4, and generally referenced by numeral 400. In the embodiment of FIG. 4, a trader may establish a stop loss concurrently with placing an order to establish a position. Fields 410, 415, and 420 may be used by a trader to place an order to establish a position in a security. If “Smart Order” selection 440 is checked, then the user defined market center preference order may be used in placing the position opening order, and/or an associated stop loss order. Alternately, the user may designate a market center to execute the order by use of the pull down menu 425. If the checkbox adjacent to the “Stop Loss” field 435 is selected the system may enter a default stop loss value or stop loss price into stop loss field 435. A “stop loss value” may refer to the difference between a market price and a stop loss price. The default stop loss value or stop loss price may be user configurable. A trader may then change the stop loss value or stop loss price if so desired. Alternately, no default stop loss value or stop loss price may be provided. The system may be configured to automatically calculate a stop loss price based on a provided stop loss value and the market price in a position opening order. Similarly, if the check box associated with “Trailing Stop” field 430 is checked, then a default trailing stop value may be used by the system. The trader may change the trailing stop value if so desired. If the checkbox adjacent to the “flag alert only” text 445 is selected, then an order may not be transferred if the trigger condition is met. Rather, a notification may be sent to the trader if the trigger condition is met.

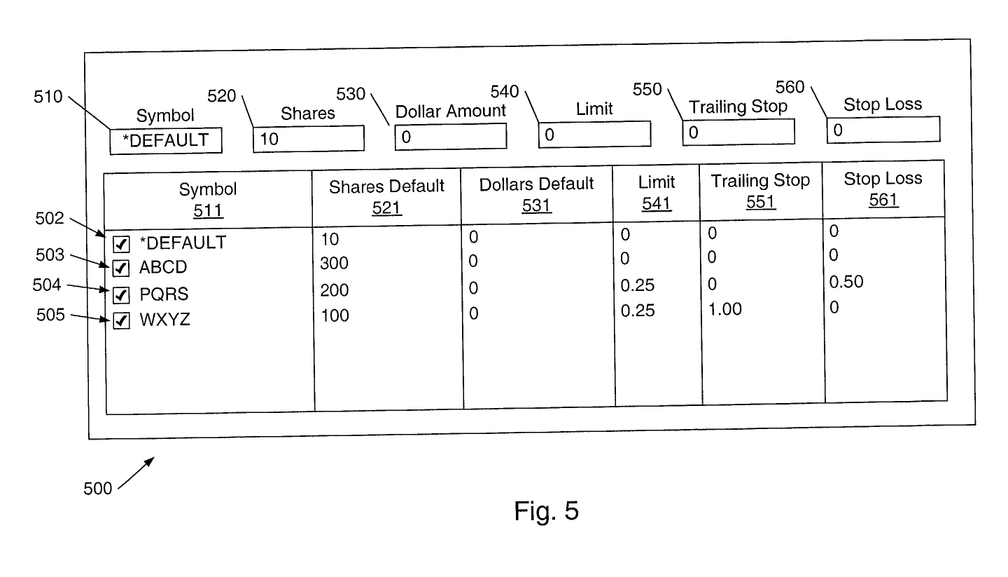

An exemplary embodiment of a user interface screen which may allow a trader to set default configurations for notifications and orders is provided in FIG. 5, and generally referenced by numeral 500. In the embodiment of FIG. 5, a trader may configure default values to be used when an order or notification is configured. For example, values provided in screen 500 may be used as default values when an order is placed using screen 400. The default values may include a limit value, a stop loss value, and/or a trailing stop value. The limit value may define a discretionary delta value as previously described. A value entered in stop loss field 560 may be used as a default stop loss value for field 435. In an embodiment, general default values may be configured as well as security specific default values. As depicted in FIG. 5, the general default values appear in the row containing the symbol “*DEFAULT” (i.e., row 502). Values in row 502 may be used as default values when an order or notification is configured for any security which does not have a security specific default listed. Examples of a security specific default configurations appears in rows 503, 504, and 505. For example, row 504 contains the symbol “PQRS” in column 511. If a user configures a notification or an order using screen 400, the values in row 504 may be used as default values. In another example, a user may type “WXYZ” in symbol field 420 of screen 400. The system may check the values entered in screen 500. The symbol “WXYZ” is identified in row 505, at column 511. The system may then fill in screen 400 using the default values provided in row 505. Thus, “100” may be entered into shares field 415 (from column 521); “1.00” may be entered into trailing stop field 430 (from column 551); and “0” may be entered into stop loss filed 435 (from column 561). The user may then modify the fields on screen 400, if so desired. The user may designate that a field is to be used by checking the checkbox associated with that field. Rather than designating a default number of shares, a user may configure the system with a default dollar value of shares. The default dollar value may appear in column 531. Column 541 may designate a limit (i.e., discretionary limit) value to be used as a default. Values in columns 511, 521, 531, 541, 551, and 561 may be entered or modified by use of fields 510, 520, 530, 540, 550, and 560, respectively.

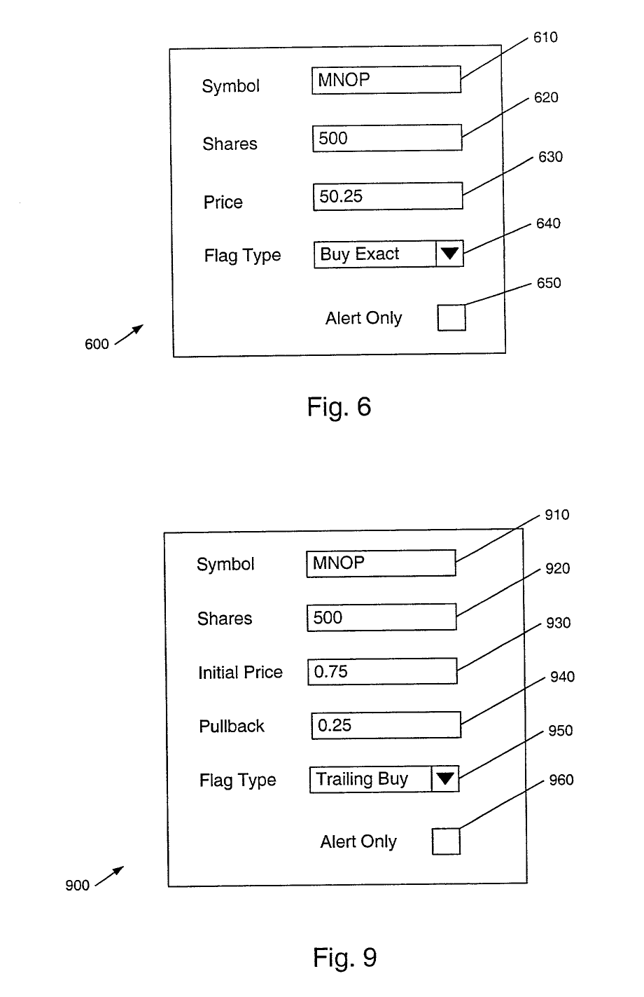

An embodiment of a user interface screen that may allow a trader to configure a trigger condition is depicted in FIG. 6 and generally referenced by numeral 600. In the embodiment of FIG. 6, a trader may establish a trigger relationship by making a selection from the “Flag Type” field 640. Examples of selections that may be available to the trader include, but are not limited to: “buy exact,” “buy higher,” “buy lower,” “sell exact,” “sell higher,” and “sell lower.” The “buy exact” selection may indicate that the trader desires to buy shares of a security (or be notified) as described in the “Symbol” (i.e., ticker symbol) field 610 (e.g., “MNOP”), “Shares” field 620 (e.g., 500), and “Price”(i.e., trigger price) field 630 (e.g., 50.25) at exactly the trigger price (i.e., at a market price equal to the trigger price). The “buy higher” selection may indicate that the trader desires to buy or to be notified if shares of a security are above the trigger price (i.e., at a market price greater than the trigger price). The “buy lower” selection may indicate that the trader desires to buy or to be notified if shares of a security are below the trigger price (i.e., at a market price less than the trigger price). The “sell exact” selection may indicate that the trader desires to sell or to be notified if shares of a security are at exactly the trigger price (i.e., at a market price equal to the trigger price). The “sell higher” selection may indicate that the trader desires to sell or to be notified if shares of a security are above the trigger price (i.e., at a market price greater than the trigger price). The “sell lower” selection may indicate that the trader desires to sell or to be notified if shares of a security are below the trigger price (i.e., at a market price less than the trigger price). If “Alert Only” check box 650 is checked, then if the trigger condition is met, the system may send a notification to the user and not submit an order.

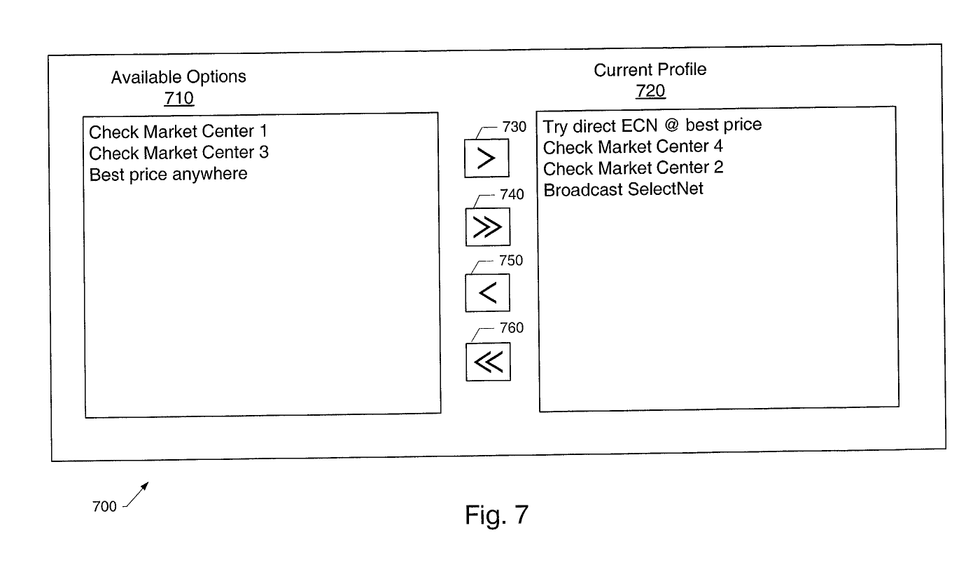

In an embodiment, the trader may also be able to configure a preferred order of market centers to contact to fill an order. The market center order may be based on user preference. An exemplary embodiment of a user configurable market center preference screen is depicted in FIG. 7, and generally referenced by numeral 700. The selection of a market center preference order may be stored within a memory of the first computer, a second computer coupled to the first computer, or both computers as a user default value. The default market center preference order may be configured by the trader. If a trader selects the “smart order” checkbox 440 of FIG. 4, the trader's market center preference list may be used in trying to fill an order. The user may be provided with a list of available options 710. A user may select one or more options from list of available options 710, to be placed in a current profile 720. For example, the options may be placed in current profile 720 in a desired order by use of control buttons 730, 740, 750, and 760. Control button 730 may be used to move an option selected from available options list 710 into current profile 720. Control button 740 may be used to move all of the options from available options list 710 into current profile 720. Control button 750 may be used to move an option selected from current profile 720 into available options list 710. Control button 760 may be used to move all of the options from current profile 720 into available options list 710. In some embodiments, an option transferred from available options list 710 into current profile 720 may go to the bottom of current profile list 720. In such embodiments, current profile list 720 may be rearranged by moving items back and forth between lists 710 and 720 until the desired order is achieved. In some embodiments, the user may be able to select an option and drag it into a desired position in current profile list 720. Depending on the configuration of the software, options listed in current profile 720 may be used in descending order or ascending order, as listed to fill an order if a trader selects smart order checkbox 430. The options may include but may not be limited to: an option for each market center available (e.g., “Check Market Center 1”); an option to route an order directly to the market center with the best price currently available (e.g., “Try direct ECN @ best price”); an option to route an order to the best available price regardless of the origin of that price (e.g., “Best price anywhere”).

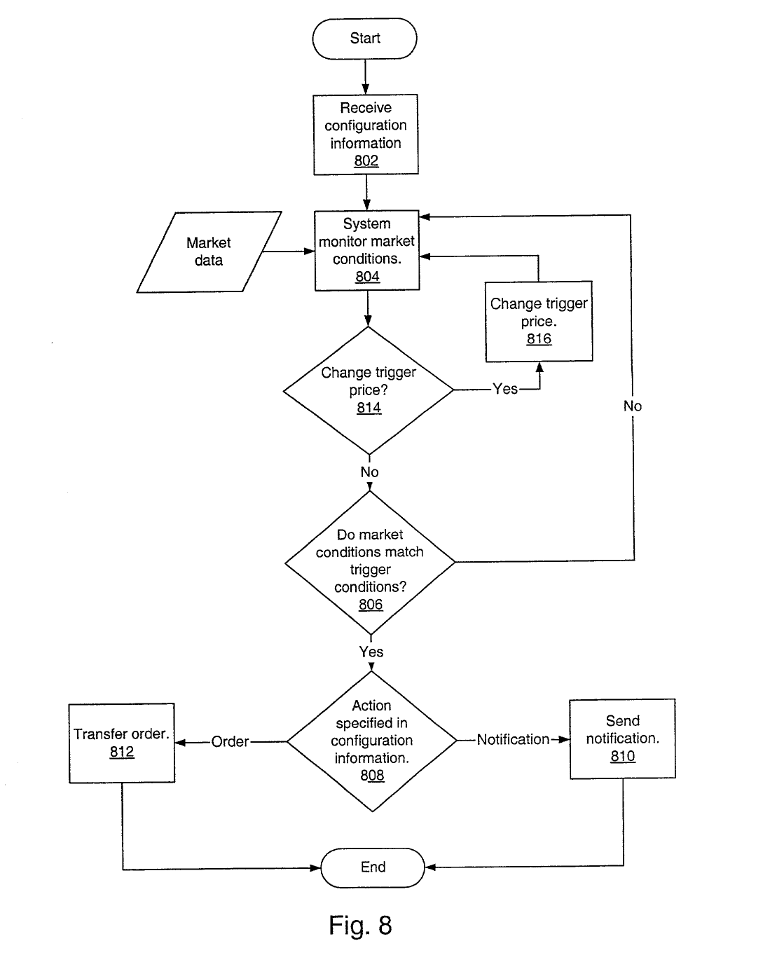

A computerized securities trading system may allow a user to configure a trailing trigger price. FIG. 8 is a flow chart of an embodiment of a computer-implemented method to implement a trailing trigger price. As used herein, a “trailing trigger price” may refer to a trigger price configured to vary with the market price of a monitored security but only in a direction that is favorable to the user. Like the method of FIG. 3, such a method may include: receiving configuration information 802, monitoring market conditions 804, determining if the market conditions meet a trigger condition 806, determining an action to be taken if a trigger condition is met 808, transferring an order 812 (if so configured), sending a notification to a trader 810 (if so configured), and displaying the status of pending orders and notifications (not shown). However, as depicted in FIG. 8, a method implementing a trailing trigger may also include determining if the trigger price should be changed 814, and changing the trigger price 816. Whether the trigger price should be changed depends on whether a monitored security's price changed in a desirable or an undesirable way. Whether a monitored price change is desirable or undesirable may be determined based on whether the user configures the trigger relationship as a trailing buy or a trailing sell. As used herein, a “trailing buy” may generally refer to a trigger relationship indicating that the system should maintain the trigger price equal to the market price of the security plus the pullback, if the market price decreases. However, if the market price of the security increases, the trigger price should not be changed. Thus, a decrease in market price may be determined to be desirable if the trigger condition includes a trailing buy. As used herein, a “trailing sell” may generally refer to a trigger relationship indicating that the system should maintain the trigger price equal to the market price of the security minus the pullback, if the market price increases. However, if the market price of the security decreases, the trigger price should not be changed. Thus, an increase in market price may be determined to be desirable if the trigger condition includes a trailing buy. For example, if the “trailing buy” selection of pull down menu 950 is chosen on the screen 900 (shown in FIG. 9), the trailing trigger price may decrease as the market price of the security decreases; however, the trailing trigger price may remain fixed if the market price of a security increases. As mentioned, in the case of a trailing buy, the initial price may be the market price plus the pullback. As used herein, the “pullback” may refer to the desired initial difference between the market price of the security and the trailing trigger price. In the case of a trailing buy, if the price of the security decreases, step 914 may determine that the trigger price should be changed. In such a case, the method may include step 816 to change the trigger price such that the trigger price trails the market price by the pullback amount. In the case of a trailing buy, if the market price begins to increase, step 814 may determine that the trigger price should not be changed. Thus, the difference between the market price and the trailing trigger price may be less than the pullback. If the market price increases by an amount equal to or greater than the pullback amount, the trigger relationship may be met. The method may then determine an action to be taken based on the received configuration information (step 808). Depending on the configuration information, the method may include notifying the trader and/or transferring an order. Conversely, in the case of a “trailing sell,” the trigger price may be increased if the market price of the security increases; however, the trigger price may remain fixed if the market price of the security decreases.

FIG. 9 depicts an exemplary embodiment of a user interface screen, which may allow a trader to configure a trailing trigger condition, generally referenced by numeral 900. The security position may be defined by the symbol (i.e., ticker symbol) field 910, shares (i.e., number of shares) field 920, and initial price field 930. The pullback may be configured by the user by use of pullback field 940. Screen 900 may also be used to configure a user notification without submitting an order. In such a case, the user may select “Alert Only” field 960.

Various embodiments further include receiving or storing instructions and/or data implemented in accordance with the foregoing description upon a carrier medium. Suitable carrier media may include storage media or memory media such as magnetic or optical media, e.g., disk or CD-ROM, as well as signals such as electrical, electromagnetic, or digital signals, conveyed via a communication medium such as networks 102 and/or 104 (as shown in FIG. 1) and/or a wireless link.

Although the system and method of the present invention have been described in connection with several embodiments, the invention is not intended to be limited to the specific forms set forth herein, but on the contrary, it is intended to cover such alternatives, modifications, and equivalents as can be reasonably included within the spirit and scope of the invention as defined by the appended claims.

While the specific examples set forth herein are generally directed to embodiments related to the NASDAQ Stock Market, it will be recognized by those skilled in the art that the embodiments disclosed herein may be applied to other stock markets as well.

It will be appreciated by those skilled in the art having the benefit of this disclosure that this invention is believed to provide methods and systems for placing and monitoring limit and stop type orders. Further modifications and alternative embodiments of various aspects of the invention will be apparent to those skilled in the art in view of this description. It is intended that the following claims be interpreted to embrace all such modifications and changes and, accordingly, the specification and drawings are to be regarded in an illustrative rather than a restrictive sense.

What is claimed:

1. A computer implemented method of providing a notification to a user, the method comprising:
receiving configuration information from a user, wherein the configuration information comprises a trigger condition and a request to send a notification to the user;
receiving market price information regarding at least the one security;
determining if a market price from the received market price information meets the trigger condition; and
sending a notification to the user if the trigger condition is met.

2. The method of claim 1, wherein the configuration information further comprises an order for at least one security; and wherein the method further comprises transferring the order to an entity for execution of the order if the market price from the received market price information meets the trigger condition.

3. The method of claim 2, further comprising displaying order information to the user after the order is transferred.

4. The method of claim 1, wherein the configuration information comprises a position closing order.

5. The method of claim 1, wherein the configuration information comprises a market center preference.

6. The method of claim 1, wherein the configuration information comprises a discretionary limit value, or discretionary limit price.

7. The method of claim 1, wherein the notification comprises an electronic mail sent to the user, a page sent to the user, or a text box displayed to the user on a user interface.

8. The method of claim 1, further comprising transferring a position opening order; wherein the configuration information comprises the position opening order.

9. The method of claim 1, further comprising transferring a position opening order before receiving configuration information from the user.

10. The method of claim 1, wherein the configuration information comprises a stop loss value, or a stop loss price.

11. The method of claim 1, wherein the trigger condition comprises a trigger value or a trigger price.

12. The method of claim 1, wherein the trigger condition comprises a trigger relationship.

13. The method of claim 12, wherein the trigger relationship comprises a less than, less than or equal to, equal to, greater than or equal to, or greater than relationship.

14. The method of claim 1, wherein the market price information comprises at least one bid price, or at least one ask price.

15. The method of claim 1, further comprising generating at least one chart using the market price information.

16. The method of claim 15, wherein the at least one chart generated comprises a trigger price or trigger value.

17. The method of claim 1, wherein the method is implemented on two or more computers connected by a network.

18. The method of claim 1, wherein the method is implemented on two or more computers connected by a network; and wherein the network comprises the Internet.

19. A computer memory medium comprising a computer executable software program configured to execute the method of claim 1.

20. A computer system configured to implement the method of claim 1.

21. A computerize-implemented method of providing a notification to a user comprising:
receiving configuration information from a user, wherein the configuration information comprises a trailing trigger condition and a request to send a notification to the user;
receiving market price information regarding at least the one security;
determining if a desirable market price change has taken place, and if so, changing the trailing trigger condition;
determining if a market price from the received market price information meets the trigger condition; and
sending a notification to the user if the trigger condition is met.

22. The method of claim 21, wherein the configuration information further comprises an order for at least one security; and wherein the method further comprises transferring the order to an entity for execution of the order if the market price from the received market price information meets the trigger condition.

23. The method of claim 22, further comprising displaying order information to the user after the order is transferred.

24. The method of claim 21, wherein the notification comprises an electronic mail sent to the user, a page sent to the user, or a text box displayed to the user on a user interface.

25. The method of claim 21, further comprising transferring a position opening order; wherein the configuration information comprises a position opening order.

26. The method of claim 21, wherein the configuration information comprises a position opening order.

27. The method of claim 21, wherein the configuration information comprises position closing order.

28. The method of claim 21, wherein the configuration information comprises a market center preference.

29. The method of claim 21, wherein the configuration information comprises a discretionary limit value, or discretionary limit price.

30. The method of claim 21, wherein the configuration information comprises a trailing stop loss initial value, or a trailing stop loss initial price.

31. The method of claim 21, wherein the configuration information comprises a pullback value.

32. The method of claim 21, wherein the trigger condition further comprise a trailing trigger value or a trailing trigger price.

33. The method of claim 21, wherein the trigger condition comprises a trailing trigger relationship.

34. The method of claim 33, wherein the trigger relationship comprises a trailing buy or a trailing sell relationship.

35. The method of claim 21, wherein the market price information comprises at least one bid price, or at least one ask price.

36. The method of claim 21, wherein the method further comprises generating at least one chart using the market price information.

37. The method of claim 36, wherein the at least one chart generated comprises a trailing trigger price or trailing trigger value.

38. The method of claim 21, wherein the method is implemented on two or more computers connected by a network.

39. The method of claim 21, wherein the method is implemented on two or more computers connected by a network; and wherein the network comprises the Internet.

40. A computer memory medium comprising a computer executable software program configured to execute the method of claim 21.

41. A computer system configured to implement the method of claim 21.
